(19) United States
(12) Patent Application Publication
(10) Pub. No.: US 2006/0037455 A1
(43) Pub. Date: Feb. 23, 2006

(54) Pattern cutter

(76) Inventors: Yeqing Deng, Dongguan City (CN); Faye Angevine, Taipei (TW)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/182,914

(22) Filed: Jul. 15, 2005

(30) Foreign Application Priority Data
Jul. 19, 2004 (CN) 200420071603.2

(51) Int. Cl. B26F 1/00

(52) U.S. Cl. 83/651; 30/315

(57) ABSTRACT

Disclosed here in the present utility model is a pattern cutter. The pattern cutter includes a base and blade. The blade is located on the base. The blade forms the shape of pattern to be cut. The said base and blade are of one-piece structure, which is machined to shape at one go through die-casting process. The height of the said blade is greater than or equal to 2.5 mm on the base. The angle of the cutting edge of blade is smaller than or equal to 60°. The said blade is surfaced with a plating coat. The present utility model is characterized by simple and rational construction, easy to make, low cost, high product accuracy and good consistency, with a wide range of adaptability and better market prospect.

### TECHNICAL FIELD

The present utility model relates generally to pattern cutting equipment and, more particularly, to a pattern cutter.

### BACKGROUND ART

The traditional paper-cutting handicrafts are a kind of work of art gaining immense popular favor. With a large variety of designs and high value of artistic appreciation, the paper-cutting handicrafts are very suitable to the kindergarten education of children. Abroad, these kind of paper-cutting products are widely used for children education. In the United States, for example, the paper-cutting products are very popularized. Generally, the paper, plastic pieces, rubber pieces or similar materials are cut into letters, cartoon, animals or human-shaped patterns for cultivation of children's cognitive ability and discrimination. But, the production efficiency is relatively low by using traditional hand paper-cutting method to make paper-cutting patterns, with a poor consistency in designs, hence it is not suitable for mass production. To overcome this deficiency, a process has been adopted to suit the mass production, i.e. firstly machining a pattern cutter for pattern cutting purpose. This pattern cutter is designed to work in such a way that the thin blade with a sharp cutting edge is bent to the pattern to be processed and it is embedded and fixed into a flat plate. Then, this pattern cutter is used to cut paper or similar flat sheet material. The material that is cut has an individual artistic pattern identical to that of the thin cutting blade, i.e. the products that are required. If the products of different shapes are to be made, what to do is only to change the pattern cutter with different shapes. In producing such pattern cutter, the thin cutting blade needs to be bent to pattern shape that is required. The existing method to form such blades is generally to bend them by hand, leading to extremely low production efficiency and poor processing accuracy. However, by use of the Forming Method and Its Equipment for Pattern Cutting Blade, which is disclosed in China Invention Patent Registration No. 01127727.0, to machine the cutting blades that are required, the blade forming speed will be greatly increased and production cost reduced. But, the technological process, through which the cutting blades are firstly machined and then assembled to a pattern cutter, will inevitably increase the processing and assembling steps, thereby the required materials and labor cost are still relatively high.

### DESCRIPTION OF THE INVENTION

The object of the present utility model is to solve those problems occurring in the prior art and provide a pattern cutter, which is simple and rational in construction, easy to produce and use, low in manufacturing cost and good in product consistency.

The object of the present utility model is accomplished by using the following technical solutions. The present pattern cutter includes a base and cutting blade. The blade is located on the base. The blade forms the pattern shape for cutting. The said base and blade are of one-piece structure and machined into shape at one go through die-casting process.

The height of the said blade is located is greater than or equal to 2.5 mm on the base. The angle at the cutting edge of said blade is smaller than or equal to 60°.

The cross sectional shape of the said blade is of triangle or combination of triangle and rectangle or combination of triangle and trapezoid.

The said cutting blade is surfaced with a plating coat, and the material of the plating coat is harder metal, e.g. chromium, nickel, zinc, etc. The said plating coat is employed to raise the hardness of the blade (i.e. the plating coat can increase the hardness of die-cast blade from around HRC10 to HRC30 and above), thus this pattern cutter is made to be more durable.

The surface of the said base is in parallel with the face of cutting blade, and both of them can be either plane or arc curved surface.

The holding legs are integrally made on the said base at the other side opposite to the surface where the cutting blade is located. The said holding legs are used for connection with other fittings or allow an operator to directly hand hold the pattern cutter in operation.

In comparison to the prior art, the present utility model has the following advantageous effects. (1) Simple and rational construction. This pattern cutter comprises a base and cutting blade of one-piece structure. The construction has been further simplified, whereas the existing pattern cutter that needs the base and cutting blade to be machined separately, then embedded and assembled. And as compared with the prior art, it is more rational and there will be no such accidents that the blade breaks loose from the base due to improper installation. So, it is safer in operation. (2) Easy to make and low in cost. The present utility model utilizes die-casting process to produce pattern cutter, with a high production rate. Generally the output is 240 pieces per hour per unit. The use of the present utility model can greatly increase work efficiency, reduce product cost and improve economy efficiency. (3) High product accuracy and good consistency. The present utility model adopts a mould in production. So long as the machining accuracy of the mould and corresponding production conditions are guaranteed, the products that are turned out can have rather high processing quality, with less product errors and good consistency.

### DESCRIPTION OF THE DRAWINGS

FIG. 1 is the structural schematic view showing the pattern cutter of the present utility model.

FIG. 2 is the structural schematic view of FIG. 1, showing the back part of the pattern cutter.

FIG. 3 is the schematic view showing another construction for the pattern cutter of the present utility model.

### DESCRIPTION OF THE PARTICULAR EMBODIMENTS

Below is a detailed description of the present utility model in conjunction with the working examples and accompanying drawings. But the implementation modes of the present utility model are not limited to those.

### WORKING EXAMPLE 1

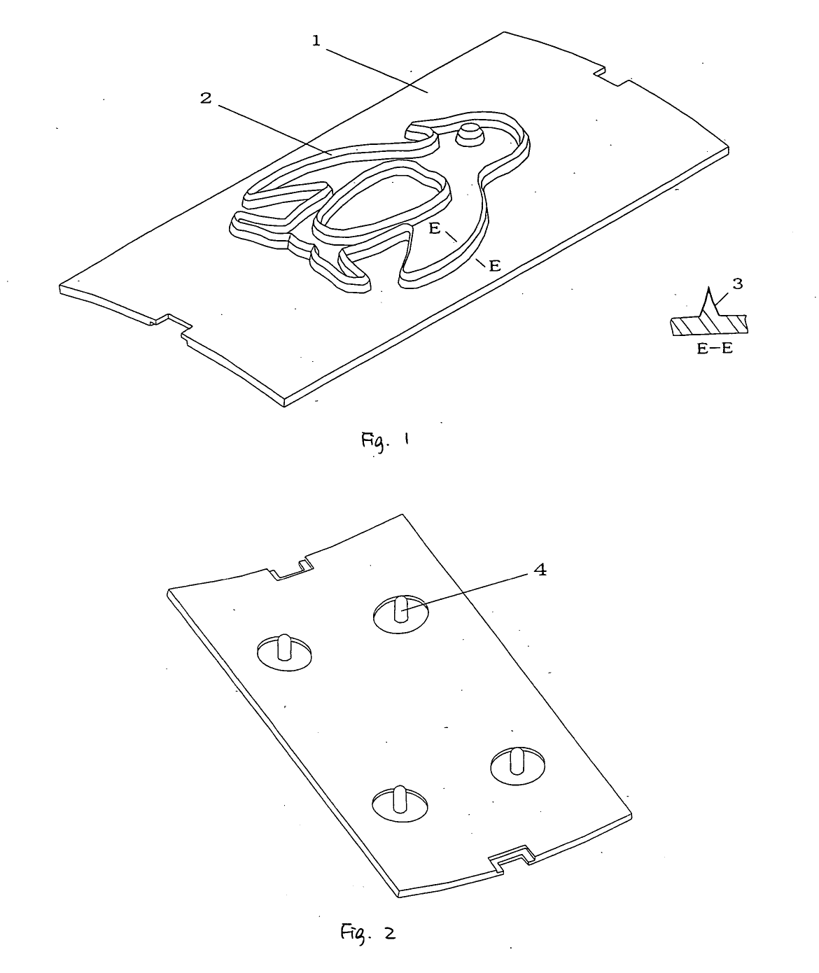

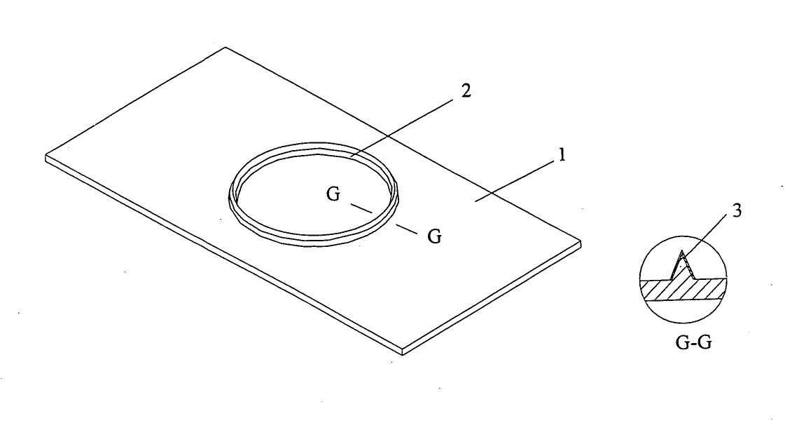

FIG. 1 and FIG. 2 show the concrete structure of the pattern cutter as set forth in the present utility model. As shown in FIG. 1, the pattern cutter is composed of the base 1 and cutting blade 2. The base 1 is an arc plate with a certain radian. The cutting blade 2 is located on the base 1, with the surface of its cutting edge being in parallel to that of base 1 (both being of arc curved surface). The cutting blade 2 forms a penguin pattern shape for cutting. The said base 1 and cutting blade 2 are of one-piece structure. The specific cross sectional structure is shown in E-E view of FIG. 1. The cutting blade 2 has a cross sectional shape similar to triangle (the exact shape is a combination of triangle and trapezoid). On the base 1, the height of cutting blade 2 is 3 mm. The cutting blade 2 has an angle of 30° at the cutting edge. On the surface of cutting blade 2 is applied a plating coat 3. Four holding legs 4 are integrally made on the said base 1 at the other side opposite to the surface where the cutting blade 2 is located, as shown in FIG. 2. The said holding legs 4 are used for connection with other fittings or allow an operator to directly hand hold the pattern cutter in operation.

### WORKING EXAMPLE 2

FIG. 3 shows another construction of the pattern cutter of the present utility model. As shown in FIG. 3, the pattern cutter consists of the base 1 and cutting blade 2. The base 1 is a flat plate. The cutting blade 2 is seated on the base 1, with the surface of its cutting edge being in parallel to that of base 1 (both being of plane). The cutting blade 2 forms a circular pattern shape to be cut. The said base 1 and cutting blade 2 are of one-piece construction. The specific cross sectional structure is shown in G-G view of FIG. 3. The cutting blade 2 has a cross sectional shape of triangle. On the base 1, the height of cutting blade 2 is 4 mm. The cutting blade 2 has an angle of 40° at the cutting edge. On the surface of cutting blade 2 is applied a plating coat 3.

1-7. (canceled)

8. A pattern cutter, comprising:
a base; and
a cutting blade integrally formed with the base as a one piece structure, the cutting blade forming the shape of a pattern to be cut, the base and the blade formed from die-cast metal in a single die-casting process.

9. The pattern cutter of claim 8, wherein the height of cutting blade is greater than or equal to 2.5 mm.

10. The pattern cutter of claim 8, wherein a cutting edge of the blade has an angle of less than or equal to approximately 60°.

11. The pattern cutter of claim 8, wherein the cross-sectional shape of the blade is of at least one of a triangle, a combination of a triangle and a rectangle and combination of a triangle and a trapezoid.

11. The pattern cutter of claim 8, further comprising a plating coat on at least the cutting blade, the plating coat increasing the hardness of the cutting blade.

12. The pattern cutter of claim 8, wherein a top surface of the base is parallel with that of a cutting edge of the cutting blade.

13. The pattern cutter of claim 12, wherein said top surface of said base and said cutting edge of the cutting blade are in parallel planes.

14. The pattern cutter of claim 12, wherein said top surface of said base and said cutting edge of the cutting blade form curved surfaces.

15. The pattern cutter of claim 8, further including holding legs integrally formed a back side of the base.

16. The pattern cutter of claim 8, wherein said pattern cutter is formed from a metal alloy.

17. The pattern cutter of claim 16, wherein said pattern cutter is formed from one of a zinc alloy and an aluminum alloy.

18. The pattern cutter of claim 8, wherein said a cutting edge of said cutting blade forms and angle of approximately 40 degrees.

19. The pattern cutter of claim 11, wherein said plating coat includes at least one of chromium, nickel and zinc.

20. The pattern cutter of claim 11, wherein said plating coat has a hardness of at least approximately HRC30.
